(19) United States
(12) Patent Application Publication
(10) Pub. No.: US 2010/0203216 A1
(43) Pub. Date: Aug. 12, 2010

(54) Fruit Spread Composition

(76) Inventor: Frederick Clifton Ross, New Vernon, NJ (US)

Correspondence Address: WOLFF & SAMSON, P.C., ONE BOLAND DRIVE, WEST ORANGE, NJ, 07052, US

(21) Appl. No.: 12/706,214

(22) Filed: Feb. 16, 2010

Related U.S. Application Data
(63) Continuation-in-part of application No. 12/496,319, filed on Jul. 1, 2009.
(60) Provisional application No. 61/133,680, filed on Jul. 1, 2008.

(51) Int. Cl. A23L 1/06; A23L 1/0524; A23L 1/064; A23L 1/068

(52) U.S. Cl. 426/577; 426/573

(57) ABSTRACT

A fruit spread is provided that includes first soluble solids from a particular fruit having between 6 and 8 percent of soluble solids in a naturally occurring form, and second soluble solids from a concentrated form of the particular fruit. The first and second soluble solids are more than 7 percent by weight of the fruit spread. The fruit spread may include pectin. The particular fruit may have between 8 and 10 percent of soluble solids, and the first and second soluble solids may be more than 8.5 percent by weight of the fruit spread. The particular fruit may have more than 10 percent of soluble solids, and the first and second soluble solids may be more than 8.5 percent by weight of the fruit spread.

### CROSS-REFERENCE TO RELATED APPLICATIONS

This application is a continuation-in-part of U.S. patent application Ser. No. 12/496,319 filed Jul. 1, 2009, and claims the benefit of U.S. Provisional Application No. 61/133,680 filed Jul. 1, 2008, both of which are incorporated herein by reference.

### FIELD OF THE INVENTION

The present invention relates generally to jams, jellies, preserves, fruit spreads and spreadable fruit. In particular, the present invention relates to a fruit spread and a fruit spread made by a process.

### BACKGROUND OF THE INVENTION

The present invention relates to jam, jelly, preserves, fruit spread and spreadable fruit. Historically, fruit (for example strawberries or apricots) was preserved so that it could be eaten year round, not just seasonally. In order to do this, the fruit was cooked in sugar or high fructose or regular corn syrup at a ratio of about 45 initial weight % fruit (i.e. strawberries) and 55 initial weight sweetener, such as sugar, high fructose corn syrup, etc.

Subsequently, fruit juice concentrates were used by some products to replace the sugar or corn syrup. White grape juice concentrate, pear juice concentrate, or a combination thereof may be used as the sweetener in these products, which are generally called 100% Fruit or All Fruit spreadable fruits. These sweeteners may be chosen because they have little impact on the flavor of the spread. Using fruit juice concentrates, 40-50 initial weight % of the fruit may be combined with 50-60 initial weight % of white grape, pear or apple concentrate. Since both the sweetener and the fruit are actually fruit, it is possible to market this product as 100% fruit. These percentages are calculated based on the weight of single strength unconcentrated fruit combined with concentrates that are concentrated between 700% to 850%. For example, combining 45 pounds of strawberries with 55 pounds of white grape juice concentrate, it takes 7 to 9 times that amount of grape juice, i.e. 385 pounds, to make 55 pounds of white grape juice concentrate.

Strawberries may be 8% solids and 92% water, and grapes, pears or apples when squeezed may have a juice that ranges between 8% and 10% solids and between 90% and 92% water. When grape juice is concentrated, it may take 8 or more pounds of grape juice to make 1 pound of grape juice concentrate. A typical method for making an “all fruit” spreadable fruit may use 8 pounds of grape juice turned into 1 pound of grape juice concentrate, mixed with 1 pound of unconcentrated strawberries. Thus, an all fruit spreadable fruit made by this conventional method may be produced from 1/9 strawberries and 8/9 grapes, as measured by weight of the original fruit. In the case of standardized jams, jellies or preserves, the final product is produced from 8/9 unconcentrated cane juice, concentrated into sugar (or the equivalent from corn, high fructose corn, sugar beat juice, etc.).

In an alternative example, 50 pounds of strawberries and 50 pounds of white grape juice concentrate may be combined to make an all fruit spread. The 50 pounds of white grape juice concentrate requires 350 pounds of grape juice to produce. The grape juice concentrate used in conventional methods may have 68% solids initially, or 34 pounds of soluble solids and 16 pounds of water. The 50 pounds of strawberries (which are 8% solids) would have 4 pounds of soluble solids, and therefore the final product will have 38 pounds of soluble solids. If the final product is a jam having 66% soluble solids, then the weight of the final product will be 58 pounds. This final product will have, though made with 50% strawberries as measured by weight compared to the grape juice concentrate, only 6.9% strawberry solids. The final product will have 60% white grape solids (4/58 and 34/58 respectively, 42 pounds of water having been boiled off while cooking).

The biggest failing in preserves, jams, fruit spreads, etc. today is that each has only a relatively small amount of the fruit by which the product is named. Consumers buying, for example, strawberry jam or fruit spread, do not realize that the product they are purchasing in fact contains very little of the fruit, i.e. strawberry, named on the label. Furthermore, the method of calculation permitted by the FDA supposedly to protect consumers has codified this method, which in its best version only contains 6.9% strawberry solids. Applicant is not aware of any forms of jams or fruit spreads made mostly from the “named” fruit (also referred to herein as the particular fruit) by which the product is called, i.e. “strawberry” jam.

### SUMMARY OF THE INVENTION

The instant invention provides the significant benefits of increasing the soluble solids in a fruit spread which are derived from a particular, named fruit.

The “particular” fruit is the fruit named on the label. This is achieved by adding a concentrated form of the particular fruit to the batch along with another sweetener, before evaporating or otherwise removing water from the combination.

A fruit spread is provided that includes first soluble solids from a particular fruit having between 6 and 8 percent of soluble solids in a naturally occurring form. The fruit spread further includes second soluble solids from a concentrated form of the same particular fruit. The first and second soluble solids are more than 7 percent by weight of the fruit spread.

A fruit spread is provided that includes first soluble solids from a particular fruit having between 8 and 10 percent of soluble solids in a naturally occurring form. The fruit spread further includes second soluble solids from a concentrated form of the same particular fruit. The first and second soluble solids are more than 8.5 percent by weight of the fruit spread.

A fruit spread is provided that includes first soluble solids from a particular fruit having more than 10 percent of soluble solids in a naturally occurring form. The fruit spread further includes second soluble solids from a concentrated form of the same particular fruit. The first and second soluble solids are more than 8.5 percent by weight of the fruit spread.

These and other advantages of the invention will be apparent to those of ordinary skill in the art by reference to the following detailed description and the accompanying drawings.

### BRIEF DESCRIPTION OF THE DRAWINGS

FIG. 1 illustrates a method according to an embodiment of the instant invention.

FIG. 2 illustrates schematically a system for making a fruit spread according to an embodiment of the instant invention.

### DETAIL DESCRIPTION

As used in the following, fruit spread includes “all fruit” fruit spreads, jams, jellies, conserves, spreadable fruit, marmalades, confitures, preserves, etc. Additionally, the present invention may be used to make fruit toppings and pie fillings, and therefore fruit spread may used to refer to these items hereinafter. Sweeteners used in the following examples and claims as “other sweeteners” may be, but are not limited to, any one or more of the following: sugar, sugar syrup, vegetable-based sweetener, corn syrup, high fructose corn syrup, honey, beet sugar syrup, rice syrup (brown or white), molasses, granulated sugar, granulated corn solids, maple syrup, grape juice concentrate (red or white), pear juice concentrate, apple juice concentrate, pineapple juice concentrate, any other concentrate made from any other fruit, sorbitol, honey, artificial sweeteners, or dietetic products made with or without aspartame, saccharin, etc. as desired for taste. The particular fruit referred to herein may be a fresh fruit, crumbled fruit, instant quick frozen (IQF), block frozen, straight pack, broken, chopped, crushed, dried, dehydrated or minced. The concentrated form of the fruit may be a puree (of 2, 3, 4 or more fold strength) a fruit juice concentrate, concentrated up to normal levels at which such concentrates are sold and marketed which range at the high end up to 65% to 72% solids.

Additionally, each of the following examples may additionally include the addition of a stabilizer, for instance (but not limited to) pectin, starch, arrowroot, gelatin, seaweed, xanthan gum, or clear gel. The stabilizer may be added prior to, during and/or after the removal of water.

Measurements in the following examples and claims may be in pounds, or alternatively be made in metric units. An initial weight or an initial total may represent a weight or percentage of a total weight of the set or combination of initial ingredients. The soluble solids in a finished product may be expressed as a weight or a percentage of the entire weight of the finished product, including water. The soluble solids derived from a particular, named fruit refers to soluble solids derived from the whole fruit, concentrated juice of the particular fruit, or any other form of the particular fruit, including purees of any particular strength. The term “concentrated form” is used in this application to refer to concentrated juices, with or without pulp, and purees of any strength.

Some fruits have 7% or greater soluble solids in a naturally occurring form, some fruits have 10% or greater soluble solids in a naturally occurring form, and some fruits have 12% or greater soluble solids in a naturally occurring form. A method according to the instant invention may provide that the percentage by weight in the fruit spread of soluble solids from the particular fruit, derived from the unprocessed form and the concentrated form, may be between 11 and 68 percent. Other fruits may have greater than 12% soluble solids in the naturally occurring form, for instance wild blueberries. In this case, the percentage by weight in the fruit spread of soluble solids from the particular fruit in the first and second quantities may be between 13 and 68 percent.

The method may produce a fruit spread having soluble solids of between 15 and 72 percent by weight, or more specifically, between 40 and 68 percent by weight. Alternatively, the method may produce a fruit spread having soluble solids of greater than 24 percent by weight.

The quantity of other sweetener, when it is a second concentrated form of a second fruit, may be between 1 and 99 percent by weight of a sub-combination of the second and third quantities.

The quantity of unprocessed fruit may represent between 1 and 60 percent by weight of an initial total of the particular fruit, the concentrated form of the particular fruit, and the other sweetener. More specifically, the quantity of unprocessed particular fruit may represent between 30 and 50 percent by weight of the initial total, or even more specifically, the quantity of unprocessed particular fruit may represent between 40 and 50 percent by weight of the initial total, by weight.

The amount of the concentrated form of the particular, named fruit may represent between 1 and 60 percent by weight of the initial total, and the quantity of other sweetener may represent between 1 and 50 percent of the initial total, by weight. More specifically, the quantity of the concentrated form of the particular, named fruit may represent between 5 and 25 percent by weight of the initial total, and the quantity of the other sweetener may represent between 30 and 50 percent by weight of the initial total.

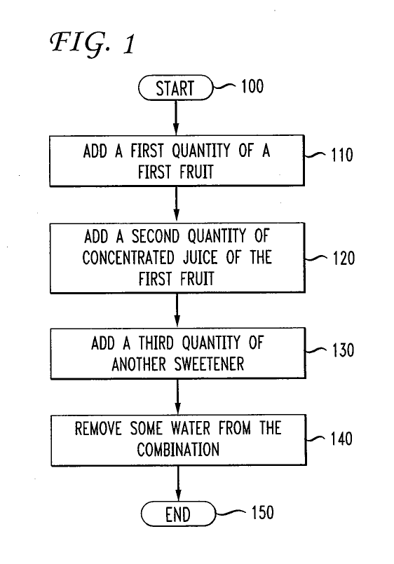

FIG. 1 illustrates the method according to the instant invention. The method starts at start circle 100 and proceeds to operation 110, which indicates to add a first quantity of a first fruit. From operation 110, the flow proceeds to operation 120, which indicates to add a second quantity of concentrated form of the first fruit. From operation 120, the flow proceeds to operation 130, which indicates to add a third quantity of another sweetener. From operation 130, the flow proceeds to operation 140, which indicates to remove some water from the combination. The water may be removed from the combination by any conventional method, including vacuum pans and/or heating. From operation 140, the flow proceeds to end circle 150. In the flow of the method, operation 130 may be optional.

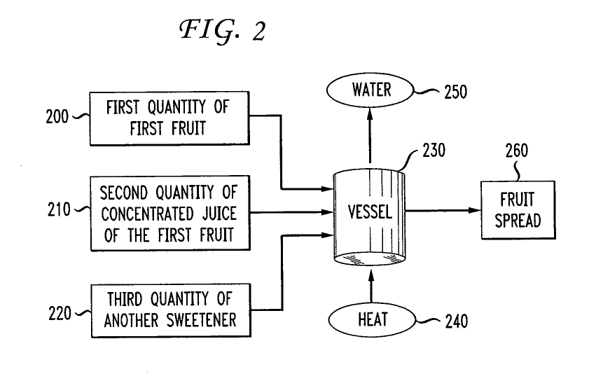

FIG. 2 illustrates schematically a system for performing a method according to the instant invention, and for making a fruit spread according to the instant invention. In FIG. 2, a first quantity of a first fruit 200 is added to a vessel 230. A second quantity of the concentrated form of the first fruit 210 is added and a third quantity of another sweetener 220 may be added to the vessel 230. Vessel 230 may be a kettle, vacuum pan, or any other appropriate device for removing water. Removing water causes sugar absorption osmosis into the fruit and equalization of solids throughout the product. Vessel 230 is heated by heat 240 in FIG. 3, though alternative arrangements for removing water 250 from vessel 230 are also possible. After water 250 is removed from vessel 230, fruit spread 260 is produced. Fruit spread 260 may be pasteurized by the heating process in vessel 230 or may thereafter be pasteurized and packaged for sale. Alternatively, if the finished product is sold as refrigerated or frozen, the pasteurization step may not be necessary. It may also be possible to sterilize product by other means such with lasers, nitrogen flush, radiation, etc. In the system, adding a third quantity of another sweetener 220 to the vessel 230 may be optional.

A percentage by weight of soluble solids in the fruit spread from the particular fruit in the first and second quantities may be between 5 and 100 percent, and more specifically may be between 11 and 60 percent, or 35 and 60 percent.

The fruit spread may include soluble solids of between 15 and 72 percent by weight, and more specifically may includes soluble solids of between 40 and 66 percent, or 50 and 66 percent by weight. However, the fruit spread may include soluble solids of greater than 24 percent by weight.

The other sweetener may be a second concentrated form of a second fruit, and the third quantity may represent between 1 and 99 percent by weight of a sub-combination of the second and third quantities.

The first quantity may represent between 0 and 60 percent by weight of a total of the first, second and third quantities, and more specifically, the first quantity may represent approximately 35 and 50 percent, or more specifically 45 percent, by weight of the total.

The second quantity may represent between 5 and 55 percent by weight of the total, and the third quantity may represent between 0 and 50 percent of the total. In particular, the second quantity may represent between 10 and 25 percent by weight of the total, or more specifically approximately 10 percent by weight of the total. The third quantity may represent approximately 45 percent by weight of the total.

The particular fruit may be strawberry, apricot, blueberry, grape, boysenberry, orange, blackberry, black raspberry, peach, pineapple, mango, guava, papaya, choke cherry, cherry, lemon, red currant, black currant, plums, bananas, or any other appropriate fruit.

The present invention provides a fruit and sweetener based product that may contain 55% by initial weight of the particular fruit listed on the label of the product. The present invention may also provide at least 50% more soluble solids in the finished product of the particular fruit that is listed on the label of the product compared to standard jams, jellies, preserves, fruit spread and spreadable fruits. In particular, a fruit spread according to the instant invention may provide up to 700% to potentially 900% more fruit solids of the named fruit than conventional fruit spreads, jams, jellies, or preserves.

The present invention makes it possible to provide a fruit spread, jam, jelly, preserve that is actually made up of at least a majority of the fruit that is used in the name of the product. For example, an apricot jam using apricot in a concentrated form would contain more than 51 initial weight percentage of apricots, in contrast to conventional apricot jams.

In one example, a strawberry jam/fruit spread is made using 1 pound of strawberry concentrate, which is itself made from 9 pounds of strawberries. The final product may be made by cooking 1 pound of whole strawberries in the strawberry concentrate. In this case the entire soluble solids of the final product are derived from strawberries.

In another example, a strawberry jam/fruit spread made as recited shown in the previous example, except the strawberry concentrate is reduced by ⅓ and replaced by grape in a concentrated form. The final product in this case would be derived from 7 pounds of strawberries and 3 pounds of grape juice. In contrast, a conventional jam may be made using 1 pound of strawberries and 1.2 pounds of sugar syrup that is made from 8 pounds of sugar cane juice, which has been concentrated.

Strawberries have 8% soluble solids. The present invention, on the other hand, uses a strawberry concentrate that is 68% soluble solids, which imparts far more strawberry solids to the final product. A conventional preserve that is 65% solids after cooking may have the following formula:

45 pounds strawberries×8% solids=3.6 pounds strawberry solids and 41.1 pounds of water in the strawberries; and

55 pounds high fructose corn syrup×71% solids=39 pounds of soluble solids and 16 pounds of water in the high fructose corn syrup.

This final conventional product cooked in a vessel (for instance, a vacuum pan or open kettle) to 65% solids will have:

3.6 pounds of strawberry solids;

39 pounds corn solids;

22.4 pounds water; and

65 pounds total finished product (35 pounds of the water is boiled off in the cooking process).

Therefore, in this conventional method, 5.5% of the finished product is soluble solids derived from strawberries.

By comparison, the following example (as one of many possible configurations) of the present invention has the following formula:

45 pounds strawberries×8% solids=3.6 pounds strawberry solids and 41.1 pounds of water in the strawberries;

18 pounds strawberry in a concentrated form×68% soluble solids=12.2 pounds strawberry solids and 5.8 pounds of water; and

37 pounds high fructose corn syrup×71% solids=26.3 pounds corn solids and 10.7 pounds of water.

The final product in this example, after being cooked (in a vacuum pan or open kettle) to 65% solids has:

15.8 pounds strawberry solids;

26.6 pounds corn solids; and

22.4 pounds water.

Therefore, this product according to the present invention will have 24.3% of the total finished product derived from strawberries, and 37.2% of the soluble solids of the finished product derived from strawberries. Note that the 15.8 pounds of strawberry solids of the present invention, compared to the 3.6 pounds of the conventional product is 339% more strawberries (439% of the strawberries found in the conventional product).

In another example, a spread is made of 30 pounds of strawberries, 35 pounds of strawberry in a concentrated form (made from 280 pounds of strawberries) and 35 pounds of white grape in a concentrated form. These components are mixed together and processed as previously discussed to produce a finished product that has 23 pounds of strawberry solids, 22 pounds of solids from grapes and 45 pounds of water. Therefore, this product may be more than 25% strawberry solids, and has substantially more strawberries in it than conventional jams, jellies, preserves, fruit spreads, spreadable fruits etc.

Alternatively, if this product was cooked to 65% solids, it could be called a preserve, and the final product would be 33% solids from strawberries compared with 5.5% solids if standard preserve formulas had been used. Therefore, the fruit spread made according to the instant invention may have 500% more strawberry solids than a conventional fruit spread.

Another exemplary embodiment provides for the use of 5% whole strawberries, 20% strawberry concentrate and 75% sugar syrup or grape in a concentrated form, as measured by the initial weight percentage. This embodiment would have four times the strawberries of conventional fruit spreads of preserves, jams or jellies. Another exemplary embodiment provides for using 13% strawberry concentrate and 87% of another sweetener, and no whole strawberries. This formulation would yield 50% more strawberry solids than conventional products.

As a comparison, conventional all fruit strawberry spreads may be made approximately with 40 pounds of strawberries and 60 pounds of white grape in a concentrated form, so that the finished product has 3.2 pounds of strawberry solids, 42 pounds of solids from grape juice and 45 pounds of water. As can be seen, the fruit spread of the present invention contains seven times more strawberries than fruit spreads of the prior art.

Alternative examples may use apricots with concentrated apricot juice. Some exemplary embodiments may use a maximum of 40% initial weight of the named fruit and 31% concentrate of the named fruit, along with 29% of a second sweetener. This sample formulation may provide 600 or 700% more of the named fruit solids than conventional jams and preserves.

In another example, 50 pounds of raspberry in a concentrated form, at 68% solids, is mixed with 30 pounds of whole raspberries. The mixture is pumped into a vacuum pan and boiled at 135 degrees Fahrenheit for 15 minutes or until the product reaches anywhere between 30% and 68% solids, depending on the final characteristics desired. Then the mixture is pumped to a pasteurization kettle and the temperature is raised to 190 degrees Fahrenheit and subsequently pumped to a filler machine. The product is filled into a container and the container is capped using steam injection (or by flipping the containers upside down for 3.5 minutes). The product is held for 3.5 minutes and then the bottles are conveyed through a bottle washer and cooling tunnel until the temperature is below 120°. This finished product, whether 30% solids or 68% solids, is made from 100% raspberries or no less than 99% if small amounts of fruit pectin are needed to create the desired texture. A method of making a fruit spread is provided that includes, among other things, adding a first quantity of a particular fruit to a vessel, and adding a second quantity of concentrated form of the particular fruit to the vessel. The method also includes adding a third quantity of another sweetener to the vessel to form a combination with the first and second quantities, and removing at least some of the water from the combination.

In the method, when the particular fruit has 7% or greater of soluble solids in a naturally occurring form, a percentage by weight of the fruit spread of soluble solids from the particular fruit in the first and second quantities may be between 7.5 and 72 percent. When the particular fruit has 10% or greater of soluble solids in the naturally occurring form, the percentage by weight in the fruit spread of soluble solids from the particular fruit in the first and second quantities may be between 9 and 68 percent. When the particular fruit has 12% or greater of soluble solids in the naturally occurring form, the percentage by weight in the fruit spread of soluble solids from the particular fruit in the first and second quantities may be between 10 and 68 percent.

In the method, a percentage by weight of soluble solids in the fruit spread from the particular fruit in the first and second quantities may be between 5 and 100 percent, or more narrowly, between 12 and 75 percent by weight. In the fruit spread, the first and second soluble solids may represent between 5 and 99 percent by weight of a total soluble solids of the fruit spread.

In the method, the fruit spread includes soluble solids of between 15 and 72 percent by weight, or more narrowly, between 30 and 66 percent by weight. Alternatively, the fruit spread includes soluble solids of greater than 24 percent by weight.

In the method, the other sweetener may be a second concentrated form of a second fruit, and the third quantity may represent between 1 and 99 percent by weight of a sub-combination of the second and third quantities. The first quantity may represent between 0 and 60 percent by weight of a total of the first, second and third quantities, or more narrowly, may represent approximately 45 percent by weight of the total. The second quantity may represent between 5 and 55 percent by weight of the total, and the third quantity may represent between 0 and 50 percent of the total. The second quantity may represents approximately 10 percent by weight of the total, and the third quantity may represent approximately 45 percent by weight of the total.

The method may include pasteurizing the combination to form the fruit spread. The particular fruit may be strawberry, apricots, blueberries, grape, boysenberry, orange, blackberry, black raspberry, peach, or raspberry.

The above-described method, which was presented in the parent application, may be used to make a fruit spread, as further described in the following. A fruit spread is provided that includes first soluble solids from a particular fruit and second soluble solids from a concentrated form of the particular fruit.

When measured against the amount of that named fruit which is used normally in spreadable fruits, for example, in a strawberry spreadable fruit, the present invention result in more strawberries (when measuring the weight of the strawberry solids derived from the strawberries and strawberry concentrate against the weight of the finished product). The present invention provides a finished product with more, 25% more, 50% more, 100% more or several hundred percent more strawberry solids than conventional jams, jellies, preserves, conserves, fruit spreads, spreadable fruits, etc., found on the market today. This may be accomplished by sweetening the fruit using a concentrated form of the same fruit. For example, if the fruit is strawberries, the concentrated form used as a sweetener would be made from strawberries or strawberries and other sweeteners so that many possible configurations of a strawberry product can be obtained, each having far more strawberries in the finished product.

One possible product resulting from the present invention includes strawberry preserves meeting the standard of identity of preserves cooked to 65/66% solids, strawberry jelly or jam. The sweeteners used may be seedless strawberry in a concentrated form or syrup alone, or in conjunction with another sweetener, as desired for taste. A jam, jelly or preserve made in a conventional method of the highest quality may be made with 50 pounds of fruit and 50 pounds of sugar or sugar syrup.

For instance, a fruit that has 12 percent solids in the naturally occurring form (for instance, blueberry) may be made into a conventional gourmet jam of the highest quality according to prior art methods using the following formula: 50 lbs of blueberries; 50 lbs of sugar; and 1 lb of pectin. The 50 lbs of blueberries with 12% soluble solids has a total of 6 lbs of soluble solids from blueberries. 50 lbs sugar plus 6 lbs blueberry solids equals 56 lbs of total soluble solids in the final product. The finished jam is cooked to 66% solids, and therefore dividing the total pounds of soluble solids (56 lbs), by 0.66 (66% solids), yields 83 lbs of finished blueberry jam. Of the finished product of 83 lbs of blueberry jam, 6 lbs is blueberry solids from the original blueberry fruit. Dividing these 6 lbs by the total weight of 83 lbs equals 7.3%, and therefore the finished product has 7.3% blueberry solids in the finished jam. In this same example, if 1 lb of pectin is added, then the total soluble solids is 57 lbs and the total weight is 86.3 lbs. In this case, the 6 lbs of blueberry solids is 6.9% of the total weight.

In contrast and in accordance with an aspect of the present invention, a concentrated form of the particular fruit (which is concentrated from the whole fruit or just from the juice and therefore may or may not include pulp) may be used to increase the percentage of soluble solids from the named, particular fruit in the final fruit spread product. Using a concentrated form of the particular fruit of the particular fruit instead of some or all of the sugar used in the conventional gourmet jam of the previous example increases the amount of soluble solids derived from the particular fruit. The method is capable of making a fruit spread with more soluble solids from the particular fruit compared with the conventional gourmet jam discussed above (using 50 lbs of fruit, 50 lbs of sugar, and 1 lb. of pectin). The method is also capable of making a fruit spread with 25% more, 50% more, 200% more, 300% more, or more of the soluble solids from the particular fruit compared with the conventional gourmet jam discussed above.

Strawberries may have soluble solids in a naturally occurring form of between 7 and 10 percent, and may be considered to have 9 percent soluble solids in the naturally occurring form. Red raspberries, black raspberries, blackberries and boysenberries may have soluble solids in a naturally occurring form of between 9 and 10 percent, and may be considered to have 10 percent soluble solids in the naturally occurring form. Blueberries, apricots and peaches may have soluble solids in a naturally occurring form of between 10 and 12 percent, and may be considered to have 12 percent soluble solids in the naturally occurring form.

The above-described percentages of soluble solids lying within the ranges for the naturally occurring form of the particular named fruit may be used to obtain the numerical value of the percentage of soluble solids from the particular named fruit made according to the method.

When the particular fruit is strawberry, first soluble solids from strawberries and the second soluble solids from a concentrated form of strawberry may be more than 7 percent, more than 8 percent, more than 9 percent, more than 10 percent, more than 16 percent or more than 21 percent by weight of the fruit spread. These percentage amounts may correspond to an amount more than the soluble solids from the particular fruit in a conventional jam, an amount 25% more, an amount 50% more, an amount 100% more, an amount 200% more, an amount 300% more, or an amount greater than 300% more than the soluble solids from the particular fruit in a conventional jam.

The particular fruit may be selected from the group consisting of red raspberries, black raspberries, blackberries and boysenberries. In this case, the first soluble solids from the particular fruit and the second soluble solids from the concentrated form of the particular fruit may be more than 8.5 percent, more than 9 percent, more than 10 percent, more than 12 percent, more than 18 percent, or more than 23.5 percent by weight of the fruit spread. These percentage amounts may correspond to an amount more than the soluble solids from the particular fruit in a conventional jam, an amount 25% more, an amount 50% more, an amount 100% more, an amount 200% more, an amount 300%, or an amount greater than 300% more than the soluble solids from the particular fruit in a conventional jam.

The particular fruit may be selected from the group consisting of blueberries, apricots and peaches. In this case, the first soluble solids from the particular fruit and the second soluble solids from the concentrated form of the particular fruit may be more than 8.5 percent, more than 10 percent, more than 12 percent, more than 14 percent, more than 21 percent, or more than 28 percent by weight of the fruit spread. These percentage amounts may correspond to an amount more than the soluble solids from the particular fruit in a conventional jam, an amount 25% more, an amount 50% more, an amount 100% more, an amount 200% more, an amount 300% more, or an amount greater than 300% more than the soluble solids from the particular fruit in a conventional jam.

Regardless of which additional sweeteners are used, the amount of fruit concentrate of the named fruit, together with the named fruit, may be more than 50% more of the amount of the named fruit than is present in typical products sold in this product category. The final product, when measured without the water (i.e., the soluble solids), has more soluble solids from a particular fruit than a conventional gourmet jam, jelly or preserve of the highest quality. The fruit spread made by the method may have 25% more soluble solids derived from the named fruit than a conventional fruit spread, or may have 50% more, 100% more, 200% more, 300% more, or more soluble solids derived from the named fruit than a conventional fruit spread. The present invention also makes it possible to produce a product made from nearly 100% strawberries, with 1% or less of fruit pectin as a stabilizer.

An exemplary embodiment of the present application also provides that the total soluble solids of the finished product may be greater than 10% by weight of the finished product, may be greater than 20% by weight of the finished product, may be greater than 30% by weight of the finished product, may be greater than 40% by weight of the finished product, may be greater than 50% by weight of the finished product, may be greater than 60% by weight of the finished product, may be greater than 65% by weight of the finished product, or may be greater than 68% by weight of the finished product. Additionally or alternatively, the soluble solids of the finished product derived from a particular fruit, both from a naturally occurring form and a concentrated form, may be greater than 90% by weight of the total soluble solids of the finished product, may be greater than 80% by weight of the total soluble solids of the finished product, may be greater than 70% by weight of the total soluble solids of the finished product, may be greater than 60% by weight of the total soluble solids of the finished product, may be greater than 50% by weight of the total soluble solids of the finished product, may be greater than 40% by weight of the total soluble solids of the finished product, may be greater than 35% by weight of the total soluble solids of the finished product, may be greater than 30% by weight of the total soluble solids of the finished product, may be greater than 25% by weight of the total soluble solids of the finished product, may be greater than 20% by weight of the total soluble solids of the finished product, may be greater than 15% by weight of the total soluble solids of the finished product, may be greater than 10% by weight of the total soluble solids of the finished product, or may be greater than 8% by weight of the total soluble solids of the finished product.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

We claim:

1. A fruit spread comprising:
first soluble solids from a particular fruit having between 6 and 8 percent of soluble solids in a naturally occurring form; and
second soluble solids from a concentrated form of the particular fruit;
wherein the first and second soluble solids are more than 7 percent by weight of the fruit spread.

2. The fruit spread of claim 1, wherein the particular fruit is strawberry.

3. The fruit spread of claim 1, wherein the first and second soluble solids are more than 8 percent by weight of the fruit spread.

4. The fruit spread of claim 3, wherein the first and second soluble solids are more than 9 percent by weight of the fruit spread.

5. The fruit spread of claim 4, wherein the first and second soluble solids are more than 10 percent by weight of the fruit spread.

6. The fruit spread of claim 5, wherein the first and second soluble solids are more than 16 percent by weight of the fruit spread.

7. The fruit spread of claim 6, wherein the first and second soluble solids are more than 21 percent by weight of the fruit spread.

8. The fruit spread of claim 1, further comprising pectin.

9. The fruit spread of claim 1, further comprising third soluble solids from a sweetener.

10. A fruit spread comprising:
first soluble solids from a particular fruit having between 8 and 10 percent of soluble solids in a naturally occurring form; and
second soluble solids from a concentrated form of the particular fruit;
wherein the first and second soluble solids are more than 8.5 percent by weight of the fruit spread.

11. The fruit spread of claim 10, wherein the particular fruit is selected from the group consisting of red raspberries, black raspberries, blackberries and boysenberries.

12. The fruit spread of claim 10, wherein the first and second soluble solids are more than 9 percent by weight of the fruit spread.

13. The fruit spread of claim 12, wherein the first and second soluble solids are more than 10 percent by weight of the fruit spread.

14. The fruit spread of claim 13, wherein the first and second soluble solids are more than 12 percent by weight of the fruit spread.

15. The fruit spread of claim 14, wherein the first and second soluble solids are more than 18 percent by weight of the fruit spread.

16. The fruit spread of claim 15, wherein the first and second soluble solids are more than 23.5 percent by weight of the fruit spread.

17. The fruit spread of claim 10, further comprising pectin.

18. The fruit spread of claim 10, further comprising third soluble solids from a sweetener.

19. A fruit spread comprising:
first soluble solids from a particular fruit having more than 10 percent of soluble solids in a naturally occurring form; and
second soluble solids from a concentrated form of the particular fruit;
wherein the first and second soluble solids are more than 8.5 percent by weight of the fruit spread.

20. The fruit spread of claim 19, wherein the particular fruit is selected from the group consisting of blueberries, apricots and peaches.

21. The fruit spread of claim 19, wherein the first and second soluble solids are more than 10 percent by weight of the fruit spread.

22. The fruit spread of claim 20, wherein the first and second soluble solids are more than 12 percent by weight of the fruit spread.

23. The fruit spread of claim 22, wherein the first and second soluble solids are more than 14 percent by weight of the fruit spread.

24. The fruit spread of claim 23, wherein the first and second soluble solids are more than 21 percent by weight of the fruit spread.

25. The fruit spread of claim 24, wherein the first and second soluble solids are more than 28 percent by weight of the fruit spread.

26. The fruit spread of claim 19, further comprising pectin.

27. The fruit spread of claim 19 further comprising third soluble solids from a sweetener.
